(19) United States
(12) Patent Application Publication
(10) Pub. No.: US 2014/0330679 A1
(43) Pub. Date: Nov. 6, 2014

(54) METHODS DEVICES AND SYSTEMS FOR PURCHASING A PRODUCT

(71) Applicant: Hershey Landau, Brooklyn, NY (US)

(72) Inventor: Hershey Landau, Brooklyn, NY (US)

(21) Appl. No.: 13/886,167

(22) Filed: May 2, 2013

(51) Int. Cl. G06Q 30/06

(52) U.S. Cl. CPC G06Q 30/0637
USPC 705/26.82

(57) ABSTRACT

The present invention includes systems and methods for purchasing a product. A consumer may purchase a token at a first location. The token may share a similar design with a product located in a second location. After purchasing the token, consumer data including a delivery address may be transmitted from a data repository accessible at the first location to a data repository accessible at the second location. Consumer data including a delivery address accessed at the second location may be used to prepare a delivery of the product to the delivery address. The token may be presented and/or validated at the time of product delivery. The product may have logistic and/or legal restrictions preventing a purchase of the product at the first location.

### FIELD OF THE INVENTION

The present invention relates generally to the field of business methods. More specifically, the present invention relates to methods, devices and systems for purchasing a product.

### BACKGROUND

Over the last few centuries, consumers have been purchasing an increasing amount of products from remote locations. As early as the mid-18^{th} century, Benjamin Franklin produced a mail order catalog selling scientific and academic books. By the late 19^{th} century, mail order catalogues became so popular that Sears produced a 532 page catalog that produced sales of hundreds of thousands of dollars. Consumers were even buying mail order pre-fabricated homes by the turn of the 20^{th} century. More recently, ordering by phones, televisions, fax machines, computers, the Internet, smartphones and tablets have become increasingly popular. Currently e-commerce has reached annual sales of hundreds of billions of dollars. The popularity of e-commerce is projected to continue to grow for the foreseeable future.

While remote purchasing of products can be more convenient than shopping at a traditional store, there are some disadvantages. A disadvantage of purchasing remotely can be buying something without seeing the actual product. While catalogs and e-commerce generally provide at least one picture with each product description, there can be a lack of multiple views. Furthermore, the actual color and size of the product can be unclear in a picture. Another disadvantage is the lack of physical contact with the product before buying. The product can't be tested, tried or used before purchasing.

While there are disadvantages, the advantages of remote shopping and purchasing have outweighed the disadvantages as popularity of e-commerce has continued to soar. One main advantage of the business model is the ability to store vast amounts of goods in large warehouses that is cheaper than localized storage. A cheaper process results in a lower price for the consumer. Furthermore, by purchasing a product remotely, the consumer can save significant travel time and can shop for products not locally available.

Certain products, for example, are restricted from being sold without a specific retailer's license. In many states, firearms, ammunition, wines and spirits are regulated and can only be sold by retailers with an appropriate license. A disadvantage of selling controlled goods can be the ability to sell the goods to a wide population. Competition can suffer, thereby causing higher prices for consumers.

The need for a greater variety of locations for selling controlled and/or restricted goods is self-evident. There is thus a need in the field of business methods for improved methods, devices and systems for purchasing a product.

### SUMMARY OF THE INVENTION

The present invention includes systems and methods for purchasing a product. According to some embodiments of the present invention, a consumer may purchase a token at a first location. The token may share a similar design with a product located in a second location. According to further embodiments of the present invention, after purchasing the token, consumer data including a delivery address may be transmitted from a data repository accessible at the first location to a data repository accessible at the second location. According to further embodiments of the present invention, consumer data including a delivery address accessed at the second location may be used to prepare a delivery of the product to the delivery address. According to further embodiments of the present invention, the token may be presented and/or validated at the time of product delivery. According to further embodiments of the present invention, the product may have logistic and/or legal restrictions preventing a purchase of the product at the first location.

According to some embodiments of the present invention, the token may share a similar front view design with an associated product. According to further embodiments of the present invention, the token may share a similar back view design with the associated product. Sharing a similar front and/or back view design may include having a similar shape (e.g. a wine bottle shape or liquor bottle shape) when viewed from the front and/or the back. According to further embodiments of the present invention, sharing a similar front and/or back view design may include having at least one design element on the front and/or back that is similar to a design element of the product. A design element may include a front and/or back label.

According to some embodiments of the present invention, a token may be produced from a substantially inexpensive single-use material, e.g. paper or any substantially thin natural or synthetic material. According to some embodiments of the present invention, a token may be produced from a substantially multi-use material, e.g. plastic, rubber or any substantially thick natural or synthetic material.

According to some embodiments of the present invention, a system for purchasing a product (Product Purchasing System—PPS) may include a communication system for delivery address transmission. The communication system may transmit a delivery address from a first location to a second location, wherein the second location may have a product available for delivery. According to further embodiments of the present invention, the communication system may be input with a delivery address acquired from a customer database associated with the first location. According to further embodiments of the present invention, the delivery address may be provided by a customer upon purchasing a token. According to some embodiments of the present invention, customer data (e.g. a customer name) may be additionally transmitted by the communication system. According to further embodiments of the present invention, product data (e.g. a barcode or any product identifier) may be additionally transmitted by the communication system. The product data transmitted by the communication system may be read and/or scanned from the token.

According to some embodiments of the present invention, the PPS may include a delivery manager for receiving a delivery address via the communication system. The delivery manager may be located in and/or accessible from the second location. According to further embodiments of the present invention, the delivery manager may receive customer data along with the delivery address. According to further embodiments of the present invention, the delivery manager may receive product data along with the delivery address. According to further embodiments of the present invention, the delivery manager may authorize a product for delivery to the received delivery address. The product delivery authorization may be based on received product data and/or customer data.

According to some embodiments of the present invention, the system may include a token validator for validating a token before finalizing a delivery of a product at a delivery address. Validating a token may include reading and/or scanning a product identifier located on the token or transmitted by a transmitter functionally associated with the token. According to further embodiments of the present invention, after validating a token, the product may be delivered to the token holder. According to further embodiments of the present invention, the product may be delivered in exchange for a validated token.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an exemplary token according to some embodiments of the present invention;

FIG. 2 shows an exemplary token according to some embodiments of the present invention;

FIG. 3 shows exemplary tokens according to some embodiments of the present invention;

FIG. 4A is a functional block diagram of an exemplary product purchasing system (PPS) according to some embodiments of the present invention; and

FIG. 4B is a flowchart including the steps of an exemplary method by which a PPS according to some embodiments of the present invention may deliver a product to a customer.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, DVDs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below.

Some embodiments of the present invention may include a method for purchasing a product. The purchasing method may include: purchasing a token at a first location, wherein the token may comprise substantially the same front view design as the product; transmitting a delivery address, in addition to at least one product identifier, to a second location for the delivery of the product; delivering the product to the delivery address; and validating the token before finalizing delivery of the product.

According to some embodiments of the present invention, providing a delivery address may further comprise transmitting a stored delivery address accessed from a first data repository at the first location. According to further embodiments of the present invention, the stored delivery address may be transmitted to a second data repository accessed at the second location.

According to some embodiments of the present invention, providing a delivery address may further comprise transmitting a delivery address provided at the first location. According to further embodiments of the present invention, the provided delivery address may be transmitted to a second data repository accessed at the second location. According to further embodiments of the present invention, the provided delivery address may be provided by a customer purchasing the token.

According to some embodiments of the present invention, the method may further comprise exchanging the token for the product. According to some embodiments of the present invention, the token may have substantially the same back view design as the product. According to some embodiments of the present invention, the product may be legally restricted from being sold at the first location.

Some embodiments of the present invention may include a product purchasing system. The product purchasing system may comprise: a token, comprising a front view design substantially the same as the product, wherein the token may be purchased at a first location; a communication system adapted to transmit, to a second location, a delivery address for the delivery of the product in addition to at least one product identifier; a delivery manager adapted to manage delivery of the product to the delivery address; and a token validator adapted to validate the token before finalizing delivery of the product.

According to some embodiments of the present invention, the communication system may be further adapted to transmit a stored delivery address accessed from a first data repository at the first location. According to further embodiments of the present invention, the delivery manager may be further adapted to receive the stored delivery address at the second location.

According to some embodiments of the present invention, the communication system may be further adapted to transmit a delivery address provided at the first location. According to further embodiments of the present invention, the communication system may be further adapted to transmit the provided delivery address to the delivery manager accessed at the second location. According to further embodiments of the present invention, the communication system may be further adapted to transmit a delivery address provided by a customer purchasing the token.

According to some embodiments of the present invention, the system may further comprise exchanging the token for the product. According to some embodiments of the present invention, the token may further comprise a back view design substantially the same as the product. According to some embodiments of the present invention, the product may be legally restricted from being sold at the first location.

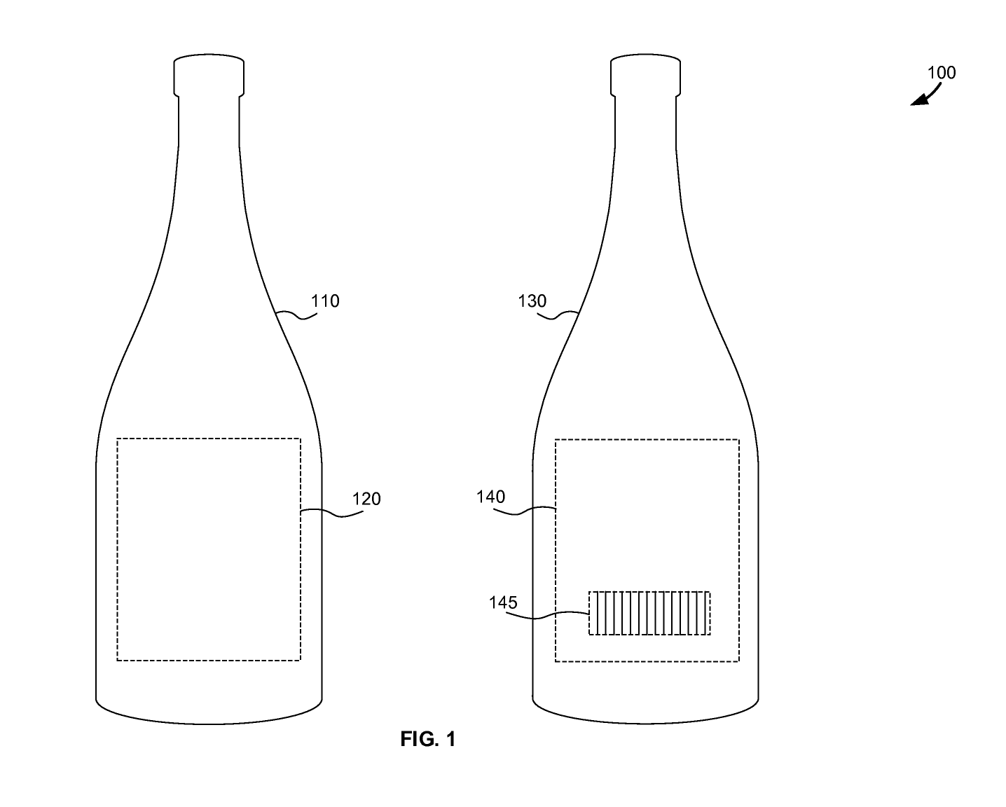

Now turning to FIG. 1, there is shown an exemplary token (100) according to some embodiments of the present invention. According to some embodiments of the present invention, a front side of the token (110) may be designed to substantially match a specific product (e.g. a specific bottle of wine, alcohol and/or spirit). The front side of the token (110) may include a design (120) that substantially matches a label on the specific product. According to some embodiments of the present invention, a back side of the token (130) may be designed to substantially match the specific product. The back side of the token (130) may include a design (140) that substantially matches a label on the specific product. The back side of the token may include a product identifying code (145—e.g. a barcode, UPC symbol, Aztec code, EZcode, QR code, etc.). The identifying code (145) may be the same code associated with the specific product.

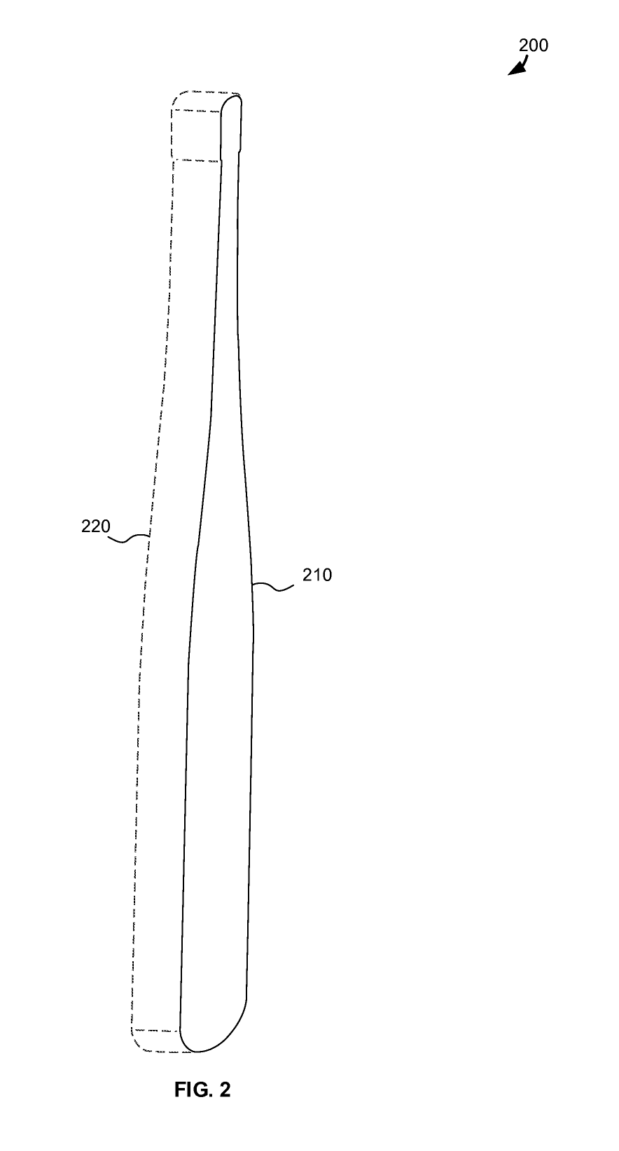

Now turning to FIG. 2, there is shown an exemplary token (200) according to some embodiments of the present invention. According to some embodiments of the present invention, the token (200) may be produced from a substantially thick or reusable material (220) such as plastic, rubber or some other natural or synthetic material. According to further embodiments of the present invention, the front and/or back design of the token (210) may be a label affixed to the substantially thick or reusable material. The front and/or back design of the token (210) may be printed on the substantially thick or reusable material.

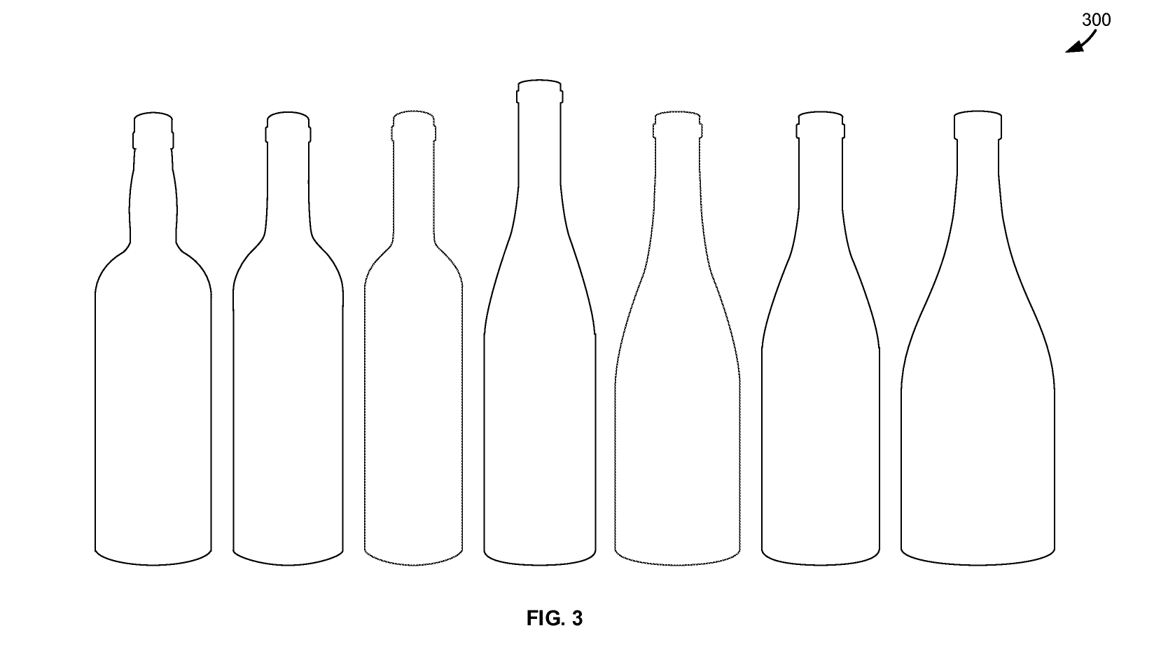

Now turning to FIG. 3, there are shown exemplary tokens (300) according to some embodiments of the present invention. According to some embodiments of the present invention, a token may be designed with the overall shape of a specific product. A plurality of token designs may be produced to match the shape of a plurality of specific products.

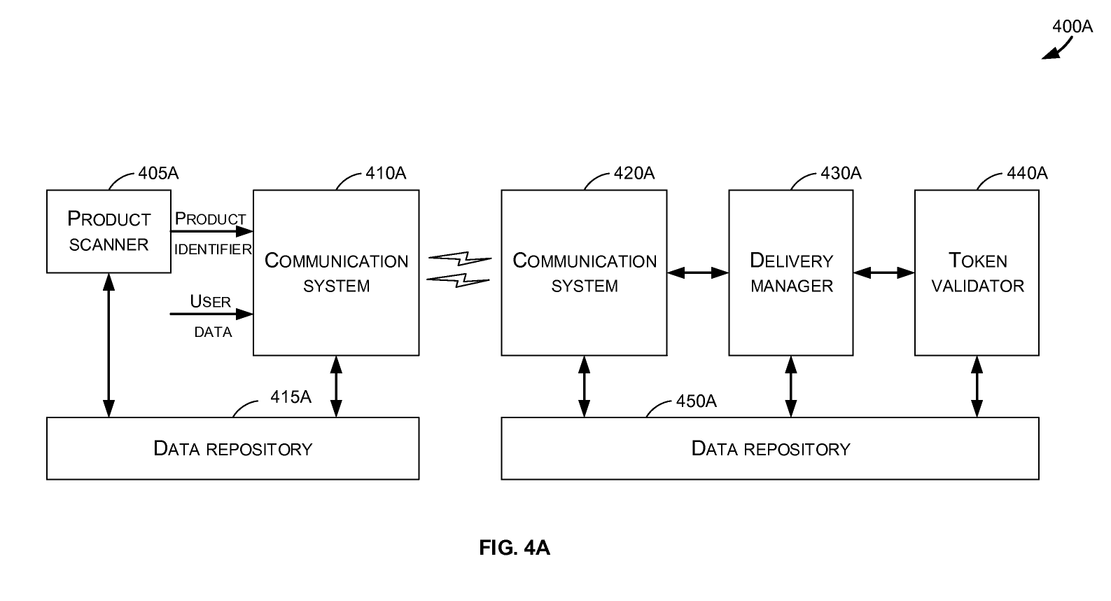

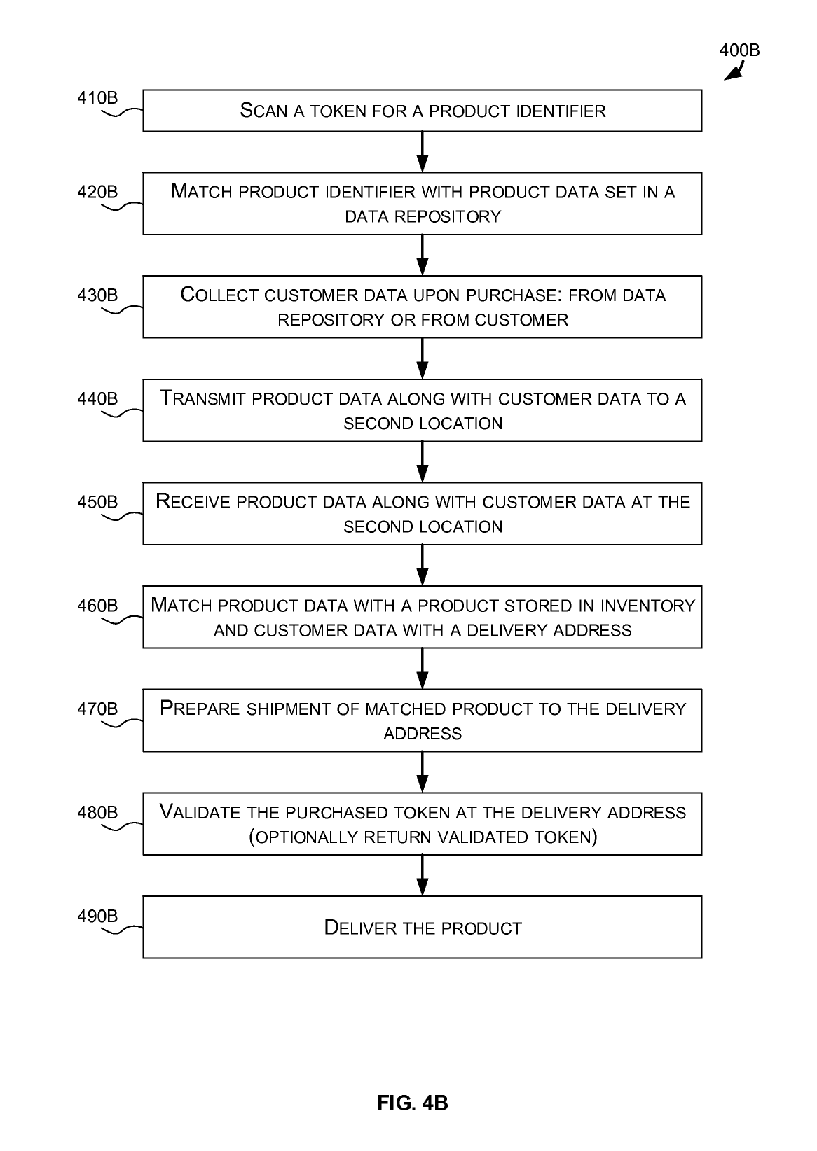

Now turning to FIG. 4A is a functional block diagram of an exemplary product purchasing system (PPS—400A) according to some embodiments of the present invention. The operation of the PPS (400A) may be described in view of 4B which is a flowchart (400B) including the steps of an exemplary method by which a PPS according to some embodiments of the present invention may deliver a product to a customer.

According to some embodiments of the present invention, a PPS (400A) may include a product scanner (405A) adapted to scan (410B) a token for a product identifier. The product identifier scan may be executed at a first location upon purchasing the token. According to further embodiments of the present invention, the product scanner (405A) may match (420B) the product identifier with a product data set stored in a functionally associated or otherwise integral data repository (415A). According to further embodiments of the present invention, user data, including a delivery address may be input into a communication system (410A). User data may be collected (430B) from the data repository (415A) or directly from the customer.

According to some embodiments of the present invention, the communication system (410A) may transmit (440B) product data along with customer data to a second location. According to further embodiments of the present invention, a corresponding communication system (420A) may receive (450B) product data along with customer data at a second location.

According to some embodiments of the present invention, a delivery manager (430A) functionally associated with or otherwise integral to the communication system (420A) may match (460B) received product data with a product stored in an inventory at the second location. Customer data may be analyzed for and/or compared to a valid delivery address stored in a functionally associated or otherwise integral data repository (450A). According to further embodiments of the present invention, the delivery manager (430A) may prepare (470B) a shipment of the matched product to the valid delivery address.

According to some embodiments of the present invention, a token validator (440A) may validate (480B) the purchased token at the delivery address. The validated token may be returned (480B) in exchange for the product upon delivery. According to further embodiments of the present invention, the product may be delivered (490B) after token validation.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can include, store, communicate, propagate, or transport the program for use by or in connection with the instruction execution system, apparatus, or device.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method for purchasing a product comprising:
purchasing a token at a first location, wherein said token comprises substantially the same front view design as said product;
transmitting a delivery address, in addition to at least one product identifier, to a second location for the delivery of said product;
delivering said product to said delivery address; and
validating said token before finalizing delivery of said product.

2. The method according to claim 1, wherein providing a delivery address further comprises transmitting a stored delivery address accessed from a first data repository at said first location.

3. The method according to claim 2, wherein said stored delivery address is transmitted to a second data repository accessed at said second location.

4. The method according to claim 1, wherein providing a delivery address further comprises transmitting a delivery address provided at said first location.

5. The method according to claim 4, wherein said provided delivery address is transmitted to a second data repository accessed at said second location.

6. The method according to claim 4, wherein said provided delivery address is provided by a customer purchasing said token.

7. The method according to claim 1, further comprising exchanging said token for said product.

8. The method according to claim 1, wherein said token has substantially the same back view design as said product.

9. The method according to claim 1, wherein said product is legally restricted from being sold at said first location.

10. A product purchasing system, said system comprising:
a token, comprising a front view design substantially the same as said product, wherein said token is purchased at a first location;
a communication system adapted to transmit, to a second location, a delivery address for the delivery of said product in addition to at least one product identifier;
a delivery manager adapted to manage delivery of said product to said delivery address; and
a token validator adapted to validate said token before finalizing delivery of said

11. The system according to claim 10, wherein said communication system is further adapted to transmit a stored delivery address accessed from a first data repository at said first location.

12. The system according to claim 11, wherein said delivery manager is further adapted to receive said stored delivery address at said second location.

13. The system according to claim 10, wherein said communication system is further adapted to transmit a delivery address provided at said first location.

14. The system according to claim 13, wherein said communication system is further adapted to transmit said provided delivery address to said delivery manager accessed at said second location.

15. The system according to claim 13, wherein said communication system is further adapted to transmit a delivery address provided by a customer purchasing said token.

16. The system according to claim 10, wherein further comprising exchanging said token for said product.

17. The system according to claim 10, wherein said token further comprises a back view design substantially the same as said product.

18. The system according to claim 10, wherein said product is legally restricted from being sold at said first location.
